(19) United States
(12) Patent Application Publication
(10) Pub. No.: US 2014/0262971 A1
(43) Pub. Date: Sep. 18, 2014

(54) TUBULAR STRUCTURE COMPONENT WITH PATTERNED RESISTIVE FILM ON INTERIOR SURFACE AND SYSTEMS AND METHODS

(71) Applicant: Micropen Technologies Corporation, Honeoye Falls, NY (US)

(72) Inventor: Alan Drumheller, Honeoye Falls, NY (US)

(21) Appl. No.: 14/218,479

(22) Filed: Mar. 18, 2014

Related U.S. Application Data
(60) Provisional application No. 61/802,923, filed on Mar. 18, 2013.

(51) Int. Cl. B03C 7/06; G01N 27/62; H01C 1/02

(52) U.S. Cl. CPC B03C 7/06; H01C 1/02; G01N 27/622
USPC 209/127.1; 427/102; 338/226; 250/281

(57) ABSTRACT

The present invention relates to a component comprising a tubular structure having interior and exterior surfaces with the interior surface defining an interior passage through the tubular structure, said tubular structure extending longitudinally between opposed ends. The component also includes a resistive film bound to the interior surface of the tubular structure having a pattern configured so that when the resistive film is connected to an electrical source, an electric field is established within the interior passage with an electrical potential that differs along the length of the interior passage while each plane perpendicular to the length of the interior passage is equipotential. Also disclosed are a method of making the component, a charged particle transportation chamber system comprising the component, and a method of identifying and/or separating charged particles.

This application claims the benefit of U.S. Provisional Patent Application Ser. No. 61/802,923, filed Mar. 18, 2013, which is hereby incorporated by reference in its entirety.

### FIELD OF THE INVENTION

The present invention relates to a tubular structure component with a patterned resistive film on the interior surface, systems containing the tubular structure component, and methods of its making and use.

### BACKGROUND OF THE INVENTION

State-of-the art charged particle detection systems (e.g., mass spectrometers, ion mobility spectrometers) include a drift tube component with complicated mechanical parts. Each component in the drift tube typically requires the assembly of multiple parts. Such complex mechanical design significantly increases the cost of charged particle detection systems and can also limit their performance. Generally, the more parts in the drift tube design, the higher the probability that the drift tube will have technical problems, such as gas leakage, inadequate temperature control, inadequate pressure control, thermal and/or electrical insulation leakage, and lack of uniformity and/or stability in resistance.

Previous publications have indicated that a uniform electric field in the drift tube of an ion mobility spectrometer is imperative to achieve high mobility resolution in such devices. See, e.g., Ching et al., “Electrospray Ionization High Resolution Ion Mobility Spectrometry/Mass Spectrometry,” Analytical Chemistry 70:4929-4938 (1998). Attempts have been made to create a uniform electric field by reducing the size of each voltage drop step and increasing the number of drift rings. Narrow drift rings have been utilized to generate the desired field distribution. However, the more drift rings that are used in a drift tube, the more lead wires are needed to be sealed at the wall to complete the drift tube structure. Structure complication greatly limits the possibility of creating highly uniform electric fields in the drift tube. U.S. Pat. No. 4,712,080 to Katou and U.S. Patent Application Publication No. 2005/0211894 to Laprade describe drift tube structures with layers of conductive coating. However, coatings that are exactly the same thickness along the drift tube have been unachievable, and conductive layers with uneven coating thickness will cause distorted electric field distributions and unpredictable system performance.

U.S. Pat. No. 8,258,468 to Wu describes a drift tube component with resistance wires wrapped on a non-conductive frame to form coils. The coil is said to generate an even and continuous electric field that guides drifting ions through an ion mobility spectrometer. However, such systems are unable to accept high voltage while generating little to no heat.

The present invention is directed to overcoming these and other deficiencies in the art.

### SUMMARY OF THE INVENTION

One aspect of the present invention relates to a component. The component includes a tubular structure having interior and exterior surfaces with the interior surface defining an interior passage through the tubular structure. The tubular structure extends longitudinally between opposed ends. The tubular structure has a resistive film bound to the interior surface having a pattern configured so that when the resistive film is connected to an electrical source, an electric field is established within the interior passage with an electrical potential that differs along the length of the interior passage while each plane perpendicular to the length of the interior passage is equipotential.

Another aspect of the present invention relates to a method of making a component. This method involves providing a tubular structure having interior and exterior surfaces with the interior surface defining an interior passage through the tubular structure. The tubular structure extends longitudinally between opposed ends. The method further involves binding a resistive film onto the interior surface of the tubular structure in a pattern configured so that when the resistive film is connected to an electrical source, an electric field is established within the interior passage with an electrical potential that differs along the length of the interior passage while each plane perpendicular to the length of the interior passage is equipotential to make the component.

A further aspect of the present invention relates to a charged particle transportation chamber system comprising the component of the present invention.

Yet another aspect of the present invention relates to a method of identifying and/or separating charged particles. This method involves providing the charged particle transportation chamber system of the present invention. A voltage is applied to the resistive film of the charged particle transportation chamber system to establish an electric field within the interior passage with an electrical potential that differs along the length of the interior passage while each plane perpendicular to the length of the interior passage is equipotential. The method further involves introducing charged particles into the interior passage under conditions effective to identify and/or separate the charged particles.

The present invention is advantageous in that it provides a monolithic tubular structure (i.e., a tubular structure and a resistive film essentially formed as one piece) that can provide a continuous, consistent, and substantially uniform temperature and/or electric field along the length of the interior passage of the tubular structure. The present invention is a simple, cost-effective component that is an improvement over existing multi-piece structures that are unable to (i) achieve a uniform and/or stable resistance through the length of the interior passage of the tubular structure or (ii) accept high voltage while generating little to no heat.

### BRIEF DESCRIPTION OF THE DRAWINGS

FIG. 1 is a perspective view of one embodiment of the component of the present invention, which is a tubular structure having interior and exterior surfaces with the interior surface defining an interior passage through the tubular structure. The interior passage has a resistive film bound to the interior surface of the tubular structure. The resistive film is configured in a helical pattern.

FIG. 2 is a partial cut-away, perspective view of the component illustrated in FIG. 1.

FIG. 3 is a cross-sectional, perspective view of the component illustrated in FIG. 1. Multiple planes perpendicular to the length of the interior passage of the tubular structure are illustrated to demonstrate the equipotential nature of the electric field in single plane within the interior passage when the helical resistive film is connected to an electrical source.

FIG. 4 is a perspective view of one embodiment of the component of the present invention, which is a tubular structure having interior and exterior surfaces with the interior surface defining an interior passage through the tubular structure. The interior passage has a resistive film bound to the interior surface of the tubular structure. The resistive film is configured in a pattern of longitudinally extending lines.

FIG. 5 is a partial cut-away, perspective view of the component illustrated in FIG. 4.

FIG. 6 is a cross-sectional, perspective view of the component illustrated in FIG. 4. Multiple planes perpendicular to the length of the interior passage of the tubular structure are illustrated to demonstrate the equipotential nature of the electric field in a single plane within the interior passage when the resistive film is connected to an electrical source and is in a pattern of longitudinally extending lines.

FIG. 7 is a perspective view of one embodiment of the component of the present invention, which is a tubular structure having interior and exterior surfaces with the interior surface defining an interior passage through the tubular structure. The interior passage has a resistive film bound to the interior surface of the tubular structure. The resistive film is configured in a pattern of conformal lines which create an uninterrupted coating along the interior passage.

FIG. 8 is a partial cut-away, perspective view of the component illustrated in FIG. 7.

FIG. 9 is a cross-sectional, perspective view of the component illustrated in FIG. 7. Multiple planes perpendicular to the length of the interior passage of the tubular structure are illustrated to demonstrate the equipotential nature of the electric field in a single plane within the interior passage when the resistive film is connected to an electrical source and is in a pattern of conformal lines which create an uninterrupted coating along the interior passage.

FIG. 10 is a perspective view of one embodiment of a method of making the component illustrated in FIG. 1. A direct writing instrument is shown to deposit a resistive film ink in a trace on the interior surface of the tubular structure in a helical pattern.

FIG. 11 is a perspective view of one embodiment of a method of making the component illustrated in FIG. 4. A direct writing instrument is shown to deposit a resistive film ink in a trace on the interior surface of the tubular structure in a pattern of a plurality of longitudinally extending lines.

FIG. 12 is a perspective view of one embodiment of a method of making the component illustrated in FIG. 7. A direct writing instrument is shown to deposit a resistive film ink in a trace on the interior surface of the tubular structure in a pattern of conformal lines which create an uninterrupted coating along the interior passage of the tubular structure.

FIG. 13 is a partial cross-sectional, perspective view of a charged particle transportation chamber system comprising the component illustrated in FIG. 1. The charged particle transportation chamber system illustrated is typical of an ion mobility spectrometer, which includes an inlet assembly, a reaction region, a gate, a charged particle transportation chamber, and a collector assembly.

### DETAILED DESCRIPTION OF THE INVENTION

One aspect of the present invention relates to a component. The component includes a tubular structure having interior and exterior surfaces with the interior surface defining an interior passage through the tubular structure. The tubular structure extends longitudinally between opposed ends. The tubular structure has a resistive film bound to the interior surface having a pattern configured so that when the resistive film is connected to an electrical source, an electric field is established within the interior passage with an electrical potential that differs along the length of the interior passage while each plane perpendicular to the length of the interior passage is equipotential.

Referring to FIG. 1, one embodiment of the component of the present invention is illustrated. Specifically, component 10 includes tubular structure 12 having interior surface 14 and exterior surface 16. Interior surface 14 defines interior passage 18, which extends longitudinally through tubular structure 12 along longitudinal axis 26. Tubular structure 12 has opposed ends, including first end 22 and second end 24. Resistive film 20 is formed on interior surface 14 of tubular structure 12.

As illustrated at first end 22 of tubular structure 12, in the particular embodiment of component 10 shown in FIG. 1, resistive film 20 has a helical pattern, although, as discussed infra, the resistive film of the component of the present invention may take on any of a variety of patterns. The helical pattern of resistive film 20 is further illustrated in FIG. 2. In FIG. 3, the helical pattern of resistive film 20 is illustrated to show that resistive film 20 is configured in a way that when resistive film 20 receives electrical energy from an electrical source to which it is connected, an electric field is established within interior passage 18 with an electrical potential that differs along the length of interior passage 18.

The resistive film of the component of the present invention may receive electrical energy from an electrical power supply, e.g., by connecting the positive terminal of a power supply (e.g., a battery) to one end of the resistive film and the negative terminal of the power supply to a second end of the resistive film. One or both ends of the tubular structure can include a connector, e.g., a conductive film or coating in contact with the resistive film for electrically connecting the resistive film to an electrical energy source (e.g., a power supply).

With further reference to FIG. 3, component 10 is able to achieve a uniform electric field in interior passage 18 at any perpendicular plane along interior passage 18. To illustrate, FIG. 3 shows three different planes perpendicular to the longitudinal direction (see arrow 32) of interior passage 18, including planes 30A, 30B, and 30C. In component 10, each plane 30A, 30B, and 30C is equipotential, meaning each plane 30A, 30B, and 30C (or any other perpendicular plane of interior passage 18) has a uniform electric field within the plane.

In the present invention, a uniform electric field at any perpendicular plane of the interior passage provides for a more uniform travel of charged particles through the interior passage and reduces noise to measurements in charged particle transportation chamber systems described infra.

The helical pattern of resistive film 20 illustrated in FIGS. 1-3 provides a continuous and substantially uniform electric field along the length of interior passage 18. In forming a helical pattern of the resistive film according to this particular embodiment of the present invention, the helical resistive film is shown to have multiple uniformly spaced turns adjacent to one another along the interior passage. By “turn” it is meant a complete circumferential travel of a segment of the helical resistive film along the interior surface of the tubular structure. Each turn is oriented at an angle from a perpendicular direction defined with respect to longitudinal axis 26 of tube 12 (see FIG. 1). In addition, each turn is electrically connected to an adjacent turn in series.

According to one embodiment, the helical pattern comprises about 1 to about 40 turns per inch which turns are spaced apart along the internal passage 18. Alternatively, the helical pattern comprises as many turns as will fit in any distance along internal passage 18 until the lines become conformal and form an uninterrupted coating along internal passage 18. Achieving equipotential planes in interior passage 18 is accomplished with the pattern of the resistive film along interior surface 14. When the pattern is helical, as it is in the particular embodiment illustrated in FIGS. 1-3, the closer the helical pattern approaches conformal lines (i.e., the closer or tighter the turns), the more likely the interior passage is to achieve a uniform electric field at perpendicular planes.

The resistive film of the component of the present invention typically has a width of about 0.1 mm to about 1 mm, although the resistive film may be narrower or wider than this range, depending on the particular size of the tubular structure and/or its intended use. In one embodiment, the geometrical characteristics of the resistive film (i.e., height or thickness and width) according to any of the patterns described herein are generally consistent throughout the length of the interior passage. According to another embodiment, the geometrical characteristics of the resistive film according to any of the patterns described herein vary throughout the length of the tubular structure. For example, the width of the resistive film may, e.g., gradually widen or narrow as it travels through the interior passage from one end of the tubular structure to the opposing end.

With reference again to FIG. 3, according to one particular embodiment of the present invention, the electric field created by resistive film 20 in interior passage 18 is in the form of an electrical potential gradient that gradually increases from one end of the tube (e.g., first end 22) to the opposed end (e.g., second end 24), while maintaining equipotential perpendicular planes within interior passage 18. According to another particular embodiment, the electric field created by resistive film 20 in interior passage 18 is in the form of an electrical potential gradient that gradually decreases from one end of the tube (e.g., first end 22) to the opposed end (e.g., second end 24), while maintaining equipotential perpendicular planes within interior passage 18.

The electrical potential gradient in the interior passage of the component of the present invention may be linear or non-linear. According to one embodiment, the electrical potential gradient is linear through the longitudinal axis of the tube (e.g., along arrow 32 of FIG. 3). A linear electrical potential gradient is achieved, e.g., with a resistive film trace that has a uniform geometry (i.e., height or thickness and width) and a uniform pattern as a function of the axial dimension of the interior passage.

In an alternative embodiment, the electrical potential gradient is non-linear through the longitudinal axis of the tube (e.g., along arrow 32 of FIG. 3). A non-linear electrical potential gradient is achieved, e.g., with a resistive film trace that has a non-uniform geometry (i.e., height or thickness and width) and a non-uniform pattern as a function of the axial dimension of the interior passage. For example, a non-linear electrical potential gradient that increases through the longitudinal axis of the interior passage can be achieved with a resistive trace that increases in height and/or width as it extends from the first end of the interior passage to the second end of the interior passage. When resistive film is in the form of a helical pattern, the helical pattern may, e.g., include more helical turns per distance as it extends from the first end of the tubular structure to the second end of the tubular structure along the interior passage.

Turning now to FIG. 4, another embodiment of the component of the present invention is illustrated. Specifically, component 110 includes tubular structure 112 having interior surface 114 and exterior surface 116. Interior surface 114 defines interior passage 118, which extends through tubular structure 112 along longitudinal axis 126. Tubular structure 112 has opposed ends, including first end 122 and second end 124. Resistive film 120 is formed on interior surface 114 of tubular structure 112.

As illustrated at first end 122 of tubular structure 112, in the particular embodiment of component 110 shown in FIG. 4, resistive film 120 has a pattern of longitudinally extending lines. This pattern of resistive film 120 is further illustrated in FIG. 5. In FIG. 6, the pattern of longitudinally extending lines of resistive film 120 is illustrated to show that resistive film 120 is configured in a way that when resistive film 120 receives electrical energy from an electrical source to which it is connected, an electric field is established within interior passage 118 with an electrical potential that differs along the length of interior passage 118.

With further reference to FIG. 6, component 110 is able to achieve a uniform electric field in interior passage 118 at any perpendicular plane along interior passage 118. To illustrate, FIG. 6 shows three different planes perpendicular to the longitudinal direction (see arrow 132) of interior passage 118, including planes 130A, 130B, and 130C. In component 110, each plane 130A, 130B, and 130C is equipotential, meaning each plane 130A, 130B, and 130C (or any other perpendicular plane of interior passage 118) has a uniform electric field within the plane.

The pattern of longitudinally extending lines for resistive film 120 illustrated in FIGS. 4-6 provides a continuous and substantially uniform electric field along the length of interior passage 118. In forming a pattern of longitudinally extending lines for resistive film 120 according to this particular embodiment of the present invention, the longitudinally extending lines are shown to be equidistant from one another around the entire circumference of interior surface 114.

With reference again to FIG. 6, according to one particular embodiment of the present invention, the electric field created by resistive film 120 in interior passage 118 is in the form of an electrical potential gradient that gradually increases from one end of the tube (e.g., first end 122) to the opposed end (e.g., second end 124), while maintaining equipotential perpendicular planes within interior passage 118. According to another particular embodiment, the electric field created by resistive film 120 in interior passage 118 is in the form of an electrical potential gradient that gradually decreases from one end of the tube (e.g., first end 122) to the opposed end (e.g., second end 124), while maintaining equipotential perpendicular planes within interior passage 118.

As noted supra, the electrical potential gradient in the interior passage of the component of the present invention may be linear or non-linear. According to one embodiment, the electrical potential gradient is linear through the longitudinal axis of the tube (e.g., along arrow 132 of FIG. 6). A linear electrical potential gradient is achieved, e.g., with a resistive film trace that has a uniform geometry (i.e., height or thickness and width) and a uniform pattern as a function of the axial dimension of the interior passage.

In an alternative embodiment, the electrical potential gradient is non-linear through the longitudinal axis of the tube (e.g., along arrow 132 of FIG. 6). A non-linear electrical potential gradient is achieved, e.g., with a resistive film trace that has a non-uniform geometry (i.e., height or thickness and width) and a non-uniform pattern as a function of the axial dimension of the interior passage. For example, a non-linear electrical potential gradient that increases through the longitudinal axis of the interior passage can be achieved with a resistive trace that increases in height and/or width as it extends from the first end of the interior passage to the second end of the interior passage. When resistive film is in the form of longitudinally extending lines, the pattern may, e.g., include more or fewer longitudinally extending lines at one end of the interior passage compared to the opposed end.

Turning now to FIG. 7, another embodiment of the component of the present invention is illustrated. Specifically, component 210 includes tubular structure 212 having interior surface 214 and exterior surface 216. Interior surface 214 defines interior passage 218, which extends through tubular structure 212 along longitudinal axis 226. Tubular structure 212 has opposed ends, including first end 222 and second end 224. Resistive film 220 is formed on interior surface 214 of tubular structure 212.

As illustrated at first end 222 of tubular structure 212, in the particular embodiment of component 210 shown in FIG. 7, resistive film 120 has a pattern of conformal lines that create an uninterrupted coating along interior passage 218 (i.e., there is no spacing between turns). This pattern of resistive film 220 is further illustrated in FIG. 8. In FIG. 9, the pattern of conformal lines that create an uninterrupted coating along interior passage 218 to form resistive film 220 is illustrated to show that resistive film 220 is configured in a way that when resistive film 220 receives electrical energy from an electrical source to which it is connected, an electric field is established within interior passage 218 with an electrical potential that differs along the length of interior passage 218.

With further reference to FIG. 9, component 210 is able to achieve a uniform electric field in interior passage 218 at any perpendicular plane along interior passage 218. To illustrate, FIG. 9 shows three different planes perpendicular to the longitudinal direction (see arrow 232) of interior passage 218, including planes 230A, 230B, and 230C. In component 210, each plane 230A, 230B, and 230C is equipotential, meaning each plane 230A, 230B, and 230C (or any other perpendicular plane of interior passage 218) has a uniform electric field within the plane.

The pattern of conformal lines for resistive film 220 illustrated in FIGS. 7-9 provides a continuous and substantially uniform electric field along the length of interior passage 218. In forming a pattern of conformal lines for resistive film 220 according to this particular embodiment of the present invention, the conformal lines are formed from a single helical resistor with turns adjacent to one another along interior surface 214.

With reference again to FIG. 9, according to one particular embodiment of the present invention, the electric field created by resistive film 220 in interior passage 218 is in the form of an electrical potential gradient that gradually increases from one end of the tube (e.g., first end 222) to the opposed end (e.g., second end 224), while maintaining equipotential perpendicular planes within interior passage 218. According to another particular embodiment, the electric field created by resistive film 220 in interior passage 218 is in the form of an electrical potential gradient that gradually decreases from one end of the tube (e.g., first end 222) to the opposed end (e.g., second end 224), while maintaining equipotential perpendicular planes within interior passage 218.

As noted supra, the electrical potential gradient in the interior passage of the component of the present invention may be linear or non-linear. According to one embodiment, the electrical potential gradient is linear through the longitudinal axis of the tube (e.g., along arrow 232 of FIG. 9). A linear electrical potential gradient is achieved, e.g., with a resistive film trace that has a uniform geometry (i.e., height or thickness and width) and a uniform pattern as a function of the axial dimension of the interior passage.

In an alternative embodiment, the electrical potential gradient is non-linear through the longitudinal axis of the tube (e.g., along arrow 232 of FIG. 9). A non-linear electrical potential gradient is achieved, e.g., with a resistive film trace that has a non-uniform geometry (i.e., height or thickness). For example, a non-linear electrical potential gradient that increases through the longitudinal axis of the interior passage can be achieved with a resistive film of conformal lines that increases in height or thickness as it extends from the first end of the interior passage to the second end of the interior passage.

In the present invention, there are several ink systems (or types of materials) suitable for forming the resistive film on the interior surface of the tubular structure. These include, without limitation, thick film cermet pastes, resistive polymeric pastes, and nanoparticle ink systems.

According to one embodiment, the resistive film is formed from a thick film cermet paste. Thick film cermet pastes typically include, in their initial compositional form, a filler, a binder (often two types of binders), and a solvent. Thick film cermet pastes are particularly suited to being applied to (i.e., bound to) substrates of, e.g., alumina, ceramic, glass, quartz, semiconductors, metals and (e.g., stainless steel). Particularly suitable substrates are those capable of surviving (e.g., maintaining form and composition) curing conditions of about 850° C., or higher.

Suitable fillers for thick film cermet pastes include, without limitation, metal and metalloid materials, as classified on the periodic table. In particular, suitable examples of fillers include oxide powders, particles and/or powders of ruthenium, glass, magnesium, calcium, zinc, titanium, zirconium, niobium, tantalum, lithium, sodium, potassium, manganese, iron, tungsten, silicon, gold, platinum, iridium, copper, palladium, chromel, alumel, rhenium, nickel-chromium-silicon, constantan, cadmium, aluminum, rhodium, molybdenum, beryllium, tin, chromium, nickel, nickel-chromium, nickel-aluminum, nickel-silicon, lead, silver, ruthenium, and mixtures thereof.

Typically, two types of binders are suitable for thick film cermet pastes. The first type includes organic and inorganic binders used as carrying agents. These binders help the material flow and wet to the surface of the substrate. These binders flow when mixed with the solvent. These first type of binders are burned off during the high temperature firing process used to cure the materials onto the substrate and are not present in the final resistive film trace. A second type of binder includes glass or oxide powders. During the highest peak of the firing process, the glass flows and acts like the “mortar” between the filler particles. The glass also fuses the printed material to the surface of the substrate and its ratio to the filler defines the system's resistivity. The higher the glass to filler ratio, the higher the resistivity (ohms/square). These binders typically are present in the final resistive film trace.

Suitable solvents for this type of system include, without limitation, paraffinic hydrocarbons such as cyclohexane; aromatic hydrocarbons such as toluene or xylene; halohydrocarbons such as methylene dichloride; ethers such as anisole or tetrahydrofuran; ketones such as acetone, methyl ethyl ketone, or methyl isobutyl ketone; aldehydes; esters such as ethyl carbonate, 4-butyrolactone, 2-ethoxyethy acetate or ethyl cinnamate; nitrogen-containing compounds such as n-methyl-2-pyrrolidone or dimethylformamide; sulfur-containing compounds such as dimethyl sulfoxide; acid halides and anhydrides; alcohols such as ethylene glycol monobutyl ether, a-terpineol, ethanol, or isopropanol; polyhydric alcohols such as glycerol or ethylene glycol; phenols; or water or mixtures thereof.

The viscosity of thick film cermet pastes is typically higher than the viscosity of the other ink systems described herein.

According to another embodiment, the resistive film is formed from a resistive polymeric paste. Resistive polymeric pastes typically include, in their initial compositional form, a filler, a binder, and a solvent. Resistive polymeric pastes are particularly suited to being applied to (i.e., bound to) substrates of, e.g., plastics, silicones, flexible polymers, alumina, ceramic, glass, quartz, semiconductors, metals and (e.g., stainless steel). Suitable substrates can typically handle processing temperatures above about 150° C.

Suitable fillers for resistive polymeric pastes include, without limitation, metal and metalloid materials, as classified on the periodic table. In particular, suitable examples of fillers include oxide powders, particles and/or powders of ruthenium, glass, magnesium, calcium, zinc, titanium, zirconium, niobium, tantalum, lithium, sodium, potassium, manganese, iron, tungsten, silicon, gold, platinum, iridium, copper, palladium, chromel, alumel, rhenium, nickel-chromium-silicon, constantan, cadmium, aluminum, rhodium, molybdenum, beryllium, tin, chromium, nickel, nickel-chromium, nickel-aluminum, nickel-silicon, lead, silver, ruthenium, and mixtures thereof.

Suitable binders for resistive polymeric pastes include, without limitation, polymeric materials such as epoxy, polyacrylate, silicone or natural rubber, polyester, polyethylene napthalate, polypropylene, polycarbonate, polystyrene, polyvinyl fluoride ethyl-vinyl acetate, ethylene acrylic acid, acetyl polymer, poly(vinyl chloride), silicone, polyurethane, polyisoprene, styrene-butadiene, acrylonitrile-butadiene-styrene, polyethylene, polyamide, polyether-amide, polyimide, polyetherimide, polyetheretherketone, polyvinylidene chloride, polyvinylidene fluoride, polycarbonate, polysulfone, polytetrafuoroethylene, polyethylene terephthalate, polyhydroxyalkanoate, polyp-xylylene), liquid crystal polymer, polymethylmethacrylate, polyhydroxyethylmethacrylate, polylactic acid, polyhydroxyvalerate, polyvinyl chloride, polyphosphazene, poly(ε-caprolactone). Copolymers or mixtures of polymers may also be used.

Suitable solvents for this type of system include, without limitation, paraffinic hydrocarbons such as cyclohexane; aromatic hydrocarbons such as toluene or xylene; halohydrocarbons such as methylene dichloride; ethers such as anisole or tetrahydrofuran; ketones such as acetone, methyl ethyl ketone, or methyl isobutyl ketone; aldehydes; esters such as ethyl carbonate, 4-butyrolactone, 2-ethoxyethy acetate or ethyl cinnamate; nitrogen-containing compounds such as n-methyl-2-pyrrolidone or dimethylformamide; sulfur-containing compounds such as dimethyl sulfoxide; acid halides and anhydrides; alcohols such as ethylene glycol monobutyl ether, a-terpineol, ethanol, or isopropanol; polyhydric alcohols such as glycerol or ethylene glycol; phenols; or water or mixtures thereof.

The viscosity of resistive polymeric pastes varies from low to high depending on the particular composition.

According to a further embodiment, the resistive film is formed from nanoparticle ink system. Nanoparticle ink systems typically include, in their initial compositional form, a filler suspended in a solvent. Nanoparticle ink systems are particularly suited to being applied to (i.e., bound to) substrates of, e.g., plastics, silicones, flexible polymers, alumina, ceramic, glass, quartz, semiconductors, and metals (e.g., stainless steel).

Suitable fillers for nanoparticle ink systems include, without limitation, pure metals, metals, and metalloid materials, as classified on the periodic table.

Suitable solvents for this type of system include, without limitation, paraffinic hydrocarbons such as cyclohexane; aromatic hydrocarbons such as toluene or xylene; halohydrocarbons such as methylene dichloride; ethers such as anisole or tetrahydrofuran; ketones such as acetone, methyl ethyl ketone, or methyl isobutyl ketone; aldehydes; esters such as ethyl carbonate, 4-butyrolactone, 2-ethoxyethy acetate or ethyl cinnamate; nitrogen-containing compounds such as n-methyl-2-pyrrolidone or dimethylformamide; sulfur-containing compounds such as dimethyl sulfoxide; acid halides and anhydrides; alcohols such as ethylene glycol monobutyl ether, a-terpineol, ethanol, or isopropanol; polyhydric alcohols such as glycerol or ethylene glycol; phenols; or water or mixtures thereof.

The viscosity of nanoparticle ink systems is typically very low.

The resistive film of the component of the present invention typically has an electrical resistance of between about 1 MΩ to about 10 GΩ (per square), or about 10 MΩ to about 1 GΩ, or about 100 MΩ to about 500 MΩ. Whatever the particular resistance, the resistive film is capable of receiving high voltage (e.g., about 1 kV to about 20 kV) while generating little to no heat.

According to one embodiment, the tubular structure of the component of the present invention is constructed of a non-conductive or insulating material. According to another embodiment, the tubular structure is constructed of a material selected from ceramic material (e.g., kaolinite, aluminum oxide, crystalline oxide, a nitride material, a carbide material, silicon carbide, or tungsten carbide), metal (e.g., stainless steel), glass, porcelain, quartz, polymer, semiconductor material, composite material, plastics, silicones, flexible polymers, alumina, and combinations thereof. These materials are exemplary only, and the tubular structure of the present invention is not limited to only these materials.

In one embodiment, the interior surface of the tubular structure is substantially free of gaps and/or cavities in which contaminants can accumulate to disrupt use of the component.

In addition, according to one embodiment, the tubular structure is formed as a single tubular structure (e.g., with unitary construction). Such construction reduces costs associated with manufacturing and/or maintenance during use.

The length and diameter of the tubular structure will depend on the particular use of the tubular structure. In one particular embodiment, the tubular structure has a length of about 1 cm to about 50 cm, or about 2 cm to about 25 cm, or about 2 cm to about 15 cm. The diameter of the interior passage will also depend on the particular use of the tubular structure. In one particular embodiment, the diameter of the interior passage is about 1 mm to about 50 mm, or about 2 mm to about 25 mm. The diameter of the exterior surface of the tubular structure also depends on the particular use of the tubular structure. In one particular embodiment, the diameter of the exterior surface is about 3 mm to about 50 mm, or about 3 mm to about 30 mm. These dimensions are provided by way of example only and are not meant to be restrictive of the present disclosure. In other configurations, the dimensions of the tubular structure exceed the dimensional ranges recited above.

Another aspect of the present invention relates to a method of making a component. This method involves providing a tubular structure having interior and exterior surfaces with the interior surface defining an interior passage through the tubular structure. The tubular structure extends longitudinally between opposed ends. The method further involves binding a resistive film onto the interior surface of the tubular structure in a pattern configured so that when the resistive film is connected to an electrical source, an electric field is established within the interior passage with an electrical potential that differs along the length of the interior passage while each plane perpendicular to the length of the interior passage is equipotential to make the component.

According to one embodiment, the method of this aspect of the present invention further involves heating the tubular structure and the resistive film after said binding. When thick film cermet pastes are used to form the resistive film, processing of the resistive film typically requires subjecting a deposited resistive film to a high temperature furnace at a temperature of about 850° C., or higher. When resistive polymeric pastes are used to form the resistive film, processing of the resistive film typically requires subjecting a deposited resistive polymeric paste to a lower temperature for cure, e.g., baking at a temperature generally below about 500° C. When nanoparticle ink systems are used to form the resistive film, processing of the resistive film typically requires subjecting a deposited nanoparticle ink system to a temperature no higher than about 150° C. During processing of the nanoparticle ink system, low temperature bake (generally around 100° C. to about 150° C.), and subsequently a higher temperature bake (generally around 200° C. to about 350° C.) sinters the nanoparticle fillers together making the trace conductive to some degree.

In one embodiment of this aspect of the present invention, binding the resistive film onto the interior surface of the tubular structure in a pattern is carried out by material deposition. There are many ways to achieve material deposition onto a substrate including, without limitation, screen printing, jetting, laser ablation, pressure driven syringe delivery, inkjet or aerosol jet droplet based deposition, laser or ion-beam material transfer, tip based deposition techniques such as dip pen lithography, electrospraying, or flow-based microdispensing.

One particularly suitable type of flow-based microdispensing employs a pen device, for example, using Micropen™ (Micropen Technologies Corp., Honeoye Falls, N.Y.) or NScrypt® technologies. Such techniques are well described in Pique et al., Direct-Write Technologies for Rapid Prototyping Applications: Sensors, Electronics, and Integrated Power Sources, Academic Press (2002), which is hereby incorporated by reference in its entirety.

According to one embodiment, binding a resistive film to the interior surface of a tubular structure according to the present invention involves flow-based microdispensing using an ink composition. By this means, one can control and manipulate the substrate to apply a uniform and precise trace on the interior surface of the tubular structure to create a resistive film that, upon receiving electrical energy, creates an electrical potential that differs along the length of the interior passage of the tubular structure with an electrical potential that differs along the length of the interior passage while each plane perpendicular to the length of the interior passage is equipotential.

One embodiment of a method of making a component of the present invention by binding a resistive film to the interior surface of the tubular structure is illustrated in FIGS. 10-12. Specifically, in FIG. 10, Micropen™ direct writing device 50 is used to dispense a resistive film ink from pen device 52 through nozzle 54 to create resistive film trace 20 formed in a helical pattern on interior surface 14 (see FIG. 2). In FIG. 11, Micropen™ direct writing device 150 is used to dispense a resistive film ink from pen device 152 through nozzle 154 to create a pattern of longitudinally extending resistive film traces 120 on interior surface 114 (see FIG. 5). In FIG. 12, Micropen™ direct writing device 250 is used to dispense a resistive film ink from pen device 252 through nozzle 254 to create a pattern of conformal lines of resistive film traces 220 on interior surface 214 which create an uninterrupted coating along the interior passage (see FIG. 8).

According to one embodiment, in carrying out this method of the present invention using a Micropen™ direct writing device, the pen device does not come into contact with the interior surface of the tubular structure during the binding step.

Microdispensing (e.g., Micropen™ direct writing) is particularly suitable for binding a resistive film onto the interior surface of the tubular structure of the present invention due to the ability to accommodate inks having an extremely wide range of rheological properties and very high solids levels, as well as excellent three dimensional substrate manipulation capabilities. As a result, any material which can be successfully dissolved or dispersed in liquid, and forms a continuous layer when dry, can be used to adhere to the interior surface of the tubular structure to form the resistive film. Particularly suitable materials, inks, and compositions are described supra.

Additives may be present in the ink, paste, or material composition forming the resistive film. Thickeners, viscosifiers, or salts may be added to adjust the rheology, resistance, and/or conductive properties of the resistive film to any particular suitable application. Surfactants, defoamers, or dispersants may be present in order to facilitate or inhibit spreading on the substrate, improve handling of the ink, improve the quality of the dispersion, or change the coefficient of friction of the dried ink. The composition can also comprise one or more surface active agents, rheology modifiers, lubricants, matting agents, spacers, pressure sensors, temperature sensors, chemical sensors, magnetic materials, radiopaque materials, conducting materials, or combinations thereof.

A further aspect of the present invention relates to a charged particle transportation chamber system comprising the component of the present invention.

A number of charged particle transportation chamber systems may benefit from the component of the present invention. In particular embodiments, the system may be a mass spectrometer or an ion mobility spectrometer. For example, the component of the present invention may be included as a drift tube component in an ion mobility spectrometer as illustrated in FIG. 13.

As described, e.g., in U.S. Pat. No. 8,258,468 to Wu, which is hereby incorporated by reference in its entirety, the basic components of a typical ion mobility spectrometer include an ionization source, a drift tube that includes a reaction region, an ion shutter grid (ion gate), a drift region, and an ion detector. In FIG. 13, ion mobility spectrometer 70 includes sample inlet 72 connected to first end 22 of component 10 at internal passage 18 for introducing a drift gas sample into internal passage 18. Ionization source 74 connected to sample inlet 72 is also provided. Ion gate 76 is positioned at or in internal passage 18 to define a reaction region and a drift region in internal passage 18. Ion mobility spectrometer 70 also includes sample outlet 80 through which a drift gas exits internal passage 18. Ion detector 78 is connected to sample outlet 80.

Another aspect of the present invention relates to a method of identifying and/or separating charged particles. This method involves providing the charged particle transportation chamber system of the present invention. A voltage is applied to the resistive film of the charged particle transportation chamber system to establish an electric field within the interior passage with an electrical potential that differs along the length of the interior passage while each plane perpendicular to the length of the interior passage is equipotential. The method further involves introducing charged particles into the interior passage under conditions effective to identify and/or separate the charged particles.

In gas phase analysis, the sample to be analyzed is introduced into the reaction region by an inert carrier gas, ionization of the sample is often accomplished by passing the sample through a reaction region and/or an ionization region. The generated ions are directed toward the drift region by an electric field that is applied to the patterned resistive film bound to the interior surface of the tubular structure which establishes the electric field. A narrow pulse of ions is then injected into, and/or allowed to enter, the drift region via an ion shutter grid (or ion gate). Once in the drift region, ions of the sample are separated based upon their ion mobilities. The arrival time of the ions at a detector is an indication of ion mobility, which can be related to ion mass. Ion mobility is not only related to ion mass, but rather is fundamentally related to the ion-drift gas interaction potential, which is not solely dependent on ion mass.

### EXAMPLES

### Example 1

### Manufacture of a Monolithic Drift Tube for an Ion Mobility Spectrometer

A 96% Alumina cylinder was obtained. A conductor ink (Heraeus 3505) was screen printed on the cylinder flange (side 1) and allowed to dry for 15 minutes at 150° C. in a box oven. This same procedure was repeated on the opposing cylinder flange (side 2) using the same conductor ink and dry time and conditions. The cylinder was then fired in a belt furnace (belt: 6″/min) for a 6-10 minute soak at 850° C.

A conductor ink (Heraeus 3505) was then printed on an outer diameter of the cylinder as an electrical shield layer (optional). The cylinder was then allowed to dry for 15 minutes at 150° C. in a box oven. The cylinder was again fired in a belt furnace (belt: 6″/min) for a 6-10 minute soak at 850° C.

A resistive film (Heraeus 91XX series blended ink for correct resistivity) was printed onto the inner diameter surface of the cylinder in a helical pattern, making sure to print the resistive film over the overhanging conductor on the inner diameter from the flange layer so as to establish an electrical connection to the flange conductor.

The printed resistive film was allowed to dry for 15 minutes at 150° C. in a box oven. The cylinder was then fired in a belt furnace (belt: 2.5″/min) for a 6-10 minute soak at 850° C.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A component comprising:
a tubular structure having interior and exterior surfaces with the interior surface defining an interior passage through the tubular structure, said tubular structure extending longitudinally between opposed ends and
a resistive film bound to the interior surface of the tubular structure having a pattern configured so that when the resistive film is connected to an electrical source, an electric field is established within the interior passage with an electrical potential that differs along the length of the interior passage while each plane perpendicular to the length of the interior passage is equipotential.

2. The component according to claim 1, wherein the pattern is helical.

3. The component according to claim 2, wherein the helical pattern comprises 1 to 40 turns per inch which turns are spaced apart along the length of the internal passage.

4. The component according to claim 1, wherein the pattern comprises conformal lines to create an uninterrupted coating along the interior passage.

5. The component according to claim 1, wherein the pattern comprises a plurality of longitudinally extending lines.

6. The component according to claim 1, wherein the tubular structure is non-conductive.

7. The component according to claim 1, wherein the tubular structure is constructed of a material selected from the group consisting of plastic, silicone, flexible polymer, alumina, ceramic, metal, polymer, porcelain, glass, quartz, a semiconductor material, a composite material, and combinations thereof.

8. The component according to claim 1, wherein the resistive film is a trace formed from a material selected from the group consisting of thick film cermet paste, resistive polymeric paste, and nanoparticle ink system.

9. The component according to claim 1, wherein the resistive film has an electrical resistance of between about 1 MΩ to about 10 GΩ.

10. The component according to claim 1, wherein the pattern is configured so that the electric field is in the form of an electric potential gradient that gradually increases from one end of the tube to the opposed end.

11. A method of making a component, said method comprising:
providing a tubular structure having interior and exterior surfaces with the interior surface defining an interior passage through the tubular structure, said tubular structure extending longitudinally between opposed ends and
binding a resistive film onto the interior surface of the tubular structure in a pattern configured so that when the resistive film is connected to an electrical source, an electric field is established within the interior passage with an electrical potential that differs along the length of the interior passage while each plane perpendicular to the length of the interior passage is equipotential to make the component.

12. The method according to claim 11 further comprising:
heating the tubular structure and the resistive film after said binding.

13. The method according to claim 11, wherein said binding is carried out by material deposition.

14. The method according to claim 13, wherein said material deposition is carried out by flow-based microdispensing.

15. The method according to claim 14, wherein said flow-based microdispensing is carried out with a pen device.

16. The method according to claim 15, wherein the pen device does not come into contact with the interior surface during said binding.

17. The method according to claim 14, wherein said flow-based microdispensing is carried out by applying lines of a resistive film ink or paste.

18. The method according to claim 17, wherein the resistive film ink or paste composition comprises a solvent and a particulate filler.

19. The method according to claim 11, wherein the resistive film has an electrical resistance of between about 1 MΩ to about 10 GΩ.

20. The method according to claim 11, wherein the pattern is configured so that the electric field is in the form of an electric potential gradient that gradually increases from one end of the tube to the opposed end.

21. The method according to claim 11, wherein the pattern is helical.

22. The method according to claim 21, wherein the helical pattern comprises 1 to 40 turns per inch which turns are spaced apart along the length of the internal passage.

23. The method according to claim 11, wherein the pattern comprises conformal lines which create an uninterrupted coating along the interior passage.

24. The method according to claim 11, wherein the pattern comprises a plurality of longitudinally extending lines.

25. The method according to claim 11, wherein the tubular structure is non-conductive.

26. The method according to claim 11, wherein the tubular structure is constructed of a material selected from the group consisting of plastic, silicone, flexible polymer, alumina, ceramic, metal, polymer, porcelain, glass, quartz, a semiconductor material, a composite material, and combinations thereof.

27. A charged particle transportation chamber system comprising the component of claim 1.

28. The system according to claim 27, wherein the system is selected from the group consisting of a mass spectrometer and an ion mobility spectrometer.

29. The system according to claim 27, wherein the pattern is helical.

30. The system according to claim 29, wherein the helical pattern comprises 1 to 40 turns per inch which turns are spaced apart along the length of the internal passage.

31. The system according to claim 27, wherein the pattern comprises conformal lines to create an uninterrupted coating along the interior passage.

32. The system according to claim 27, wherein the pattern comprises a plurality of longitudinally extending lines.

33. The system according to claim 27, wherein the tubular structure is non-conductive.

34. The system according to claim 27, wherein the tubular structure is constructed of a material selected from the group consisting of plastic, silicone, flexible polymer, alumina, ceramic, metal, polymer, porcelain, glass, quartz, a semiconductor material, a composite material, and combinations thereof.

35. The system according to claim 27, wherein the resistive film is a trace formed from a material selected from the group consisting of thick film cermet paste, resistive polymeric paste, and nanoparticle ink system.

36. The system according to claim 27, wherein the resistive film has an electrical resistance of between about 1 MΩ and 10 GΩ.

37. A method of identifying and/or separating charged particles, said method comprising:
providing the system according to claim 27;
applying a voltage to the resistive film to establish an electric field within the interior passage with an electrical potential that differs along the length of the interior passage while each plane perpendicular to the length of the interior passage is equipotential; and
introducing charged particles into the interior passage under conditions effective to identify and/or separate the charged particles.

38. The method according to claim 37, wherein the pattern is helical.

39. The method according to claim 38, wherein the helical pattern comprises 1 to 40 turns per inch which turns are spaced apart along the length of the internal passage.

40. The method according to claim 37, wherein the pattern comprises conformal lines to create an uninterrupted coating along the interior passage.

41. The method according to claim 37, wherein the pattern comprises a plurality of longitudinally extending lines.

42. The method according to claim 37, wherein the tubular structure is non-conductive.

43. The method according to claim 37, wherein the tubular structure is constructed of a material selected from the group consisting of plastic, silicone, flexible polymer, alumina, ceramic, metal, polymer, porcelain, glass, quartz, a semiconductor material, a composite material, and combinations thereof.

44. The method according to claim 37, wherein the resistive film is a trace comprising a solvent, a binder, and a particulate filler.

45. The method according to claim 37, wherein the resistive film has an electrical resistance of between about 1 MΩ and 10 GΩ.

46. The method according to claim 37, wherein the pattern is configured so that the electric field is in the form of an electric potential gradient that gradually increases from one end of the tube to the opposed end.
